(19) United States
(12) Patent Application Publication
(10) Pub. No.: US 2021/0049711 A1
(43) Pub. Date: Feb. 18, 2021

(54) METHOD OF AUTOMATICALLY TRANSMITTING DATA INFORMATION AND DEVICE OF AUTOMATICALLY TRANSMITTING DATA INFORMATION

(71) Applicants: HEFEI XINSHENG OPTOELECTRONICS TECHNOLOGY CO., LTD., Hefei (CN); BOE TECHNOLOGY GROUP CO., LTD., Beijing (CN)

(72) Inventor: Junwei CHEN, Beijing (CN)

(21) Appl. No.: 16/832,619

(22) Filed: Mar. 27, 2020

(30) Foreign Application Priority Data
Aug. 15, 2019 (CN) 201910753771.0

(51) Int. Cl. G06Q 50/04; G06Q 10/08; G06Q 30/00; G06Q 10/10; G06F 16/23; G06F 16/25; G06F 16/28

(52) U.S. Cl. CPC G06Q 50/04; G06Q 10/0875; G06Q 30/0185; G06F 16/285; G06F 16/2365; G06F 16/254; G06Q 10/10

(57) ABSTRACT

A method of automatically transmitting data information and a device of automatically transmitting data information are provided. The method of automatically transmitting data information includes: receiving a bill of materials; determining controlled material information from the bill of materials, the material information including at least material category information; determining an extraction logic matching the material category information; extracting material information from the controlled material information according to the extraction logic; and storing the extracted material information into a material library of a manufacturing execution system to control an extraction of a material from the material library for production in a production process according to the material information. The present disclosure is applied to automatically extracting product master data information that needs to be maintained through an MES.

### CROSS-REFERENCE TO RELATED APPLICATION

This application claims a priority to Chinese Patent Application No. 201910753771.0 filed in China on Aug. 15, 2019, the disclosure of which is incorporated herein in its entirety by reference.

### TECHNICAL FIELD

The present disclosure relates to the field of a Manufacturing Execution System (MES) technology, in particular to a method of automatically transmitting data information and a device of automatically transmitting data information.

### BACKGROUND

With continuous development of big data technology and cloud computing, a transition from a “manufacturing” enterprise to an “intelligent manufacturing” enterprise is an irresistible trend. Data information, such as product master data information, is an essential and core data resource in a process such as enterprise research and development, manufacturing, and financial accounting. How to realize instant and accurate information exchange and sharing between different systems is extremely important.

### SUMMARY

In an aspect, a method of automatically transmitting data information is provided in the present disclosure, including:

receiving a bill of materials;

determining controlled material information from the bill of materials, the material information including at least material category information;

determining an extraction logic matching the material category information;

extracting material information from the controlled material information according to the extraction logic; and

storing the extracted material information into a material library of a manufacturing execution system to control an extraction of a material from the material library for production in a production process according to the material information.

Optionally, the receiving the bill of materials includes:

receiving the bill of materials sent by a product lifecycle management using an enterprise service bus.

Optionally, the method further includes:

generating a rule template configured to verify the material information;

generating a first identifier corresponding to the material information according to a plurality of attribute information included in the material information of the material library through the rule template;

obtaining the first identifier corresponding to the material information of the material in response to the extraction of the material from the material library;

verifying whether the first identifier is the same as a first identifier marked on a material entity; and

determining to release the material entity into production when the first identifier is the same as the first identifier marked on the material entity.

Optionally, the determining the controlled material information from the bill of materials includes:

obtaining description information of a material from the bill of materials;

determining the material category information corresponding to the material according to the description information;

determining that the material corresponding to the material category information is within a control range according to the material category information; and

searching the bill of materials according to the material category information, and obtaining material information included by the material corresponding to the material category information.

Optionally, the determining that the material corresponding to the material category information is within the control range according to the material category information includes:

predetermining a first mapping relationship between the material category information and a control identifier, wherein the control identifier is configured to indicate that a material marked with the control identifier is within the control range;

determining whether there is a control identifier matching the determined material category information according to the first mapping relationship; and

determining that the material corresponding to the material category information is within the control range when there is the control identifier matching the determined material category information.

Optionally, prior to the determining the extraction logic matching the material category information, the method further includes:

decomposing the material category information into a plurality of material types, and obtaining a correspondence relationship between the material category information and the plurality of material types;

allocating preset extraction logics to the plurality of material types; and

establishing a second mapping relationship between each of the plurality of material types and a corresponding preset extraction logic.

Optionally, the method further includes:

predetermining a correspondence relationship between the material category information and a coding segment, wherein the coding segment is obtained by coding the material category information using a customized coding method; and

establishing a third mapping relationship between the material category information, the coding segment, the preset extraction logic and the plurality of material types by storing the correspondence relationship between the material category information and the plurality of material types, the second mapping relationship and the correspondence relationship between the material category information and the coding segment into a same data mapping table.

Optionally, the determining the extraction logic matching the material category information includes:

determining the extraction logic matching the material category information according to the material category information and the third mapping relationship.

Optionally, the extracting the material information from the controlled material information according to the extraction logic includes:

obtaining description information of a material from the controlled material information;

determining the material category information corresponding to the material according to the description information;

searching the data mapping table through the material category information, and obtaining the preset extraction logic corresponding to the material category information;

determining whether there is an extraction logic matching the description information in the preset extraction logic; and

extracting the material information included by the material corresponding to the description information when there is the extraction logic matching the description information in the preset extraction logic.

Optionally, the method further includes:

obtaining the extraction logic matching the description information when determining there is the extraction logic matching the description information in the preset extraction logic;

searching the data mapping table through the extraction logic, and obtaining a material type corresponding to the extraction logic;

determining a matching relationship between the description information and the material type according to the material type corresponding to the extraction logic; and

determining the material type to which the material information including the description information belongs according to the matching relationship between the description information and the material type.

In another aspect, a device of automatically transmitting data information is further provided in the present disclosure, including:

a determining circuit configured to receive a bill of materials, and determine controlled material information from the bill of materials, the material information including at least material category information;

an extracting circuit configured to determine an extraction logic matching the material category information, and extract material information from the controlled material information according to the extraction logic; and

a storing circuit configured to store the material information extracted by the extracting circuit into a material library of a manufacturing execution system to control an extraction of a material from the material library for production in a production process according to the material information.

Optionally, the determining circuit is further configured to receive the bill of materials sent by a product lifecycle management using an enterprise service bus.

Optionally, the device further includes:

a generating circuit configured to generate a rule template configured to verify the material information; and generate a first identifier corresponding to the material information according to a plurality of attribute information included in the material information of the material library through the rule template;

a obtaining circuit configured to obtain the first identifier corresponding to the material information of the material in response to the extraction of the material from the material library;

a verifying circuit configured to verify whether the first identifier is the same as a first identifier marked on a material entity; and

the determining circuit is further configured to determine to release the material entity into production when the first identifier is the same as the first identifier marked on the material entity.

Optionally, the determining circuit is further configured to:

obtain description information of a material from the bill of materials;

determine the material category information corresponding to the material according to the obtained description information;

determine that the material corresponding to the material category information is within a control range according to the material category information; and

search the bill of materials according to the material category information, and obtain material information included by the material corresponding to the material category information.

Optionally, the determining circuit is further configured to:

predetermine a first mapping relationship between the material category information and a control identifier, wherein the control identifier is configured to indicate that a material marked with the control identifier is within the control range;

determine whether there is a control identifier matching the determined material category information according to the first mapping relationship; and

determine that the material corresponding to the material category information is within the control range when there is the control identifier matching the determined material category information.

Optionally, the device further includes:

a decomposing circuit configured to decompose the material category information into a plurality of material types, and obtain a correspondence relationship between the material category information and the plurality of material types;

an allocating circuit configured to allocate preset extraction logics to the plurality of material types; and

an establishing circuit configured to establish a second mapping relationship between each of the plurality of material types and a corresponding preset extraction logic.

Optionally, the establishing circuit is further configured to:

predetermine a correspondence relationship between the material category information and a coding segment, wherein the coding segment is obtained by coding the material category information using a customized coding method; and

establish a third mapping relationship between the material category information, the coding segment, the preset extraction logic and the plurality of material types by storing the correspondence relationship between the material category information and the plurality of material types, the second mapping relationship and the correspondence relationship between the material category information and the coding segment into a same data mapping table.

Optionally, the determining circuit is further configured to determine the extraction logic matching the material category information according to the material category information and the third mapping relationship.

Optionally, the extracting circuit is further configured to:

obtain description information of a material from the controlled material information;

determine the material category information corresponding to the material according to the description information;

search the data mapping table through the material category information and obtain the preset extraction logic corresponding to the material category information;

determine whether there is an extraction logic matching the description information in the preset extraction logic; and

extract the material information included by the material corresponding to the description information when there is the extraction logic matching the description information in the preset extraction logic.

Optionally, the extracting circuit is further configured to:

obtain the extraction logic matching the description information when determining there is the extraction logic matching the description information in the preset extraction logic;

search the data mapping table through the extraction logic and obtain a material type corresponding to the extraction logic;

determine a matching relationship between the description information and the material type according to the material type corresponding to the extraction logic; and

determine the material type to which the material information including the description information belongs according to the matching relationship between the description information and the material type.

In another aspect, an electronic device is further provided in the present disclosure, including: a memory, a processor, and a program stored in the memory and executable by the processor, wherein the processor is configured to execute the program to perform the method of automatically transmitting the data information as described above.

In another aspect, a computer-readable storage medium is further provided in the present disclosure, storing a computer program, where the computer program is executed to perform the method of automatically transmitting the data information as described above.

### BRIEF DESCRIPTION OF THE DRAWINGS

Various other advantages and benefits will become apparent to those of ordinary skill in the art upon reading detailed description of optional embodiments below. The drawings are only for a purpose of illustrating the optional embodiments and are not to be considered as limitations to the present disclosure. Moreover, same reference numerals are used throughout the drawings to denote same parts. In the drawing:

FIG. 1 is a flowchart of a method of automatically transmitting data information in an embodiment of the present disclosure;

FIG. 2 is a flowchart of a method of automatically transmitting data information in another embodiment of the present disclosure;

FIG. 3 is a block diagram of a device of automatically transmitting data information in an embodiment of the present disclosure; and

FIG. 4 is a block diagram of a device of automatically transmitting data information in another embodiment of the present disclosure.

### DETAILED DESCRIPTION

Exemplary embodiments of the present disclosure will be described hereinafter in more detail with reference to the accompanying drawings. Although exemplary embodiments of the present disclosure are shown in the drawings, it should be appreciated that the present disclosure may be implemented in various forms and should not be limited by the embodiments set forth herein. On the contrary, these embodiments are provided to enable a thorough understanding of the present disclosure, and to fully convey the scope of the present disclosure to those of skill in the art.

At present, a Bill of Materials (BOM) is created and maintained in a Product Lifecycle Management (PLM) during a process of an enterprise product from research and development to meeting a mass production release requirement. When a mass production release stage is reached, a mass production BOM includes all materials used in a manufacturing process, as well as information such as amount information of the materials used in the BOM, description information of the materials, and whether the materials are substituted for each other. The mass production BOM is sent by the PLM to an Enterprise Resource Planning (ERP) as a basis for purchasing, reserving, receiving, and financial accounting of various materials. At the same time, a small part of the materials in the mass production BOM needs to be controlled for a production link. This part of the materials are usually maintained to a Manufacturing Execution System (MES) as product master data information.

However, in the related art, the product master data information maintained by the MES needs to be manually input by a person in charge of production management after communicating with multiple business departments separately and confirmation offline. The communication and confirmation is a time-consuming process. Further, a maintenance manner of input manually has disadvantages of human cost, information lag, error-prone, inefficient communication and low level of informatization.

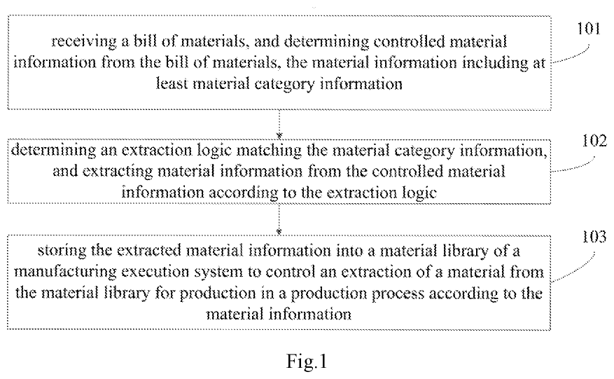

In order to solve the above technical issues, a method of automatically transmitting data information is provided in an embodiment of the present disclosure. As shown in FIG. 1, product master data information to be maintained is automatically extracted from entire BOM data by an MES in the method, that is, automatic transmission of the product master data information between a PLM and the MES is realized to complete inputting information automatically into the MES. The following specific steps are provided in the embodiment of the present disclosure.

Step 101, receiving a bill of materials, and determining controlled material information from the bill of materials, the material information including at least material category information.

In some embodiments, after receiving the bill of materials sent by the product lifecycle management using an enterprise service bus, the controlled material information is determined from the bill of materials, the material information includes at least material category information.

The Bill of Materials (BOM) is updated continuously during a process of a product from research and development to mass production in a large manufacturing enterprise. The BOM is created and maintained by the Product Lifecycle Management (PLM), when meeting a mass production release requirement, the BOM includes all materials used in a manufacturing process, as well as information such as amount information of the materials used in the BOM, description information of the materials, and whether the materials are substituted for each other.

In the embodiment of the present disclosure, while the mass production BOM is sent by the PLM to the ERP, an entire BOM data is sent to the Enterprise Service Bus (ESB). The controlled key material information is obtained from the entire BOM data received from the ESB through the MES.

For example, the following Table 1 lists some of attribute columns included in the entire BOM of a product mass production stage in the PLM: “Searching Number”, “Component ID”, “Version” and “Version Description”.

TABLE 1

| Searching Number | Component ID | Version | Version Description |
|---|---|---|---|
| NO. 1 | XXX | 0 | POL_10.1WUXGA_F_03_0-TAC_HC_ADS_/ |
| . . . | . . . | . . . | . . . |

“Searching Number” refers to a sequence number of the material in the BOM. “Component ID” is equivalent to a material ID. Usually, “Component ID” is obtained by editing according to an enterprise customized coding method, and is simply expressed as “XXX” without specific examples. “Version” refers to a version of the material. “Version Description” may include description information about category, size, utilized position, etc. of the material. Generally, a customized character string is used to express the description information, so that a short string may be used by replacing a long text to express rich content information, which is clear to those of skill in the art. For example: in “POL_10.1WUXGA_F_03_0-TAC_HC_ADS_/”, “POL” is a polarizer, “10.1WUXGA” refers to a size of the polarizer, and “WUXGA” is an abbreviation of Widescreen Ultra eXtended Graphics Array, which means a UXGA format with a resolution of 1920×1200 and an aspect ratio of 16:10.

It should be noted that, the entire BOM may further include other attribute columns such as “Product Number”, “Material group”, “Substitution group”. Table 1 is only an example of the attribute columns included in the BOM and an example of a piece of material information, which is not a limitation to the BOM.

In the embodiment of the present disclosure, it is necessary to control a small part of key materials in the received entire BOM data. A criteria for determining whether a material is required to be controlled may be, but is not limited to: a price of the material, a category of the material, a utilized position of the material, etc. In the embodiment of the present disclosure, the controlled material information may be obtained from the entire BOM data sent to the ESB according to a preset control requirement.

Step 102, determining an extraction logic matching the material category information, and extracting material information from the controlled material information according to the extraction logic.

In the embodiment of the present disclosure, a mapping relationship between the material category information and the extraction logic may be predetermined, then specified material information may be extracted through the corresponding extraction logic from the controlled material information according to different material category information and the mapping relationship. For example, an extraction logic of “POL” may be to extract an “F” after a second underscore in version description information “POL_10.1WUXGA_F_03_0-TAC_HC_ADS_/”. The character “F” denotes a utilized position of a material. Then, the exemplary extraction logic is to extract the material of a material category “POL” and meeting the corresponding utilized position “F”, so as to obtain the material information included in the extracted material from the controlled material information through an extraction operation.

In the embodiment of the present disclosure, a purpose of further extracting the matching material information from the controlled material information is to use the extracted material information as the product master data information and put it into the MES for maintenance.

Step 103, storing the extracted material information into a material library of a manufacturing execution system to control an extraction of a material from the material library for production in a production process according to the material information.

In the embodiment of the present disclosure, the extracted material information is used as the product master data information and stored into the material library created in the MES, so as to achieve control and maintenance of the product master data information in the production process.

The method of automatically transmitting data information is provided in the embodiment of the present disclosure. While the mass production BOM is sent by the PLM to the ERP, the entire BOM data is sent to the Enterprise Service Bus (ESB). The controlled key material information is obtained from the entire BOM data received from the ESB through the MES, and the material information that needs to be maintained, i.e., the product master data information, is further extracted from the controlled key material information. Compared with the related art, the problems of low data input efficiency and insufficient timely and accurate maintenance caused by the manual input of the product master data information are solved. The product master data information that needs to be maintained is automatically extracted through the MES in the embodiment of the present disclosure, that is, the automatic transmission of the product master data information between the PLM and the MES is realized, and inputting information automatically into the MES is completed, thereby improving an efficiency of inputting the product master data information into the MES. The automatic input, rather than the manual input , is used in the present disclosure to avoid finding that the material information to be maintained is not maintained just before releasing, thereby ensuring an efficiency, timeliness and accuracy of the MES maintenance of the product master data information.

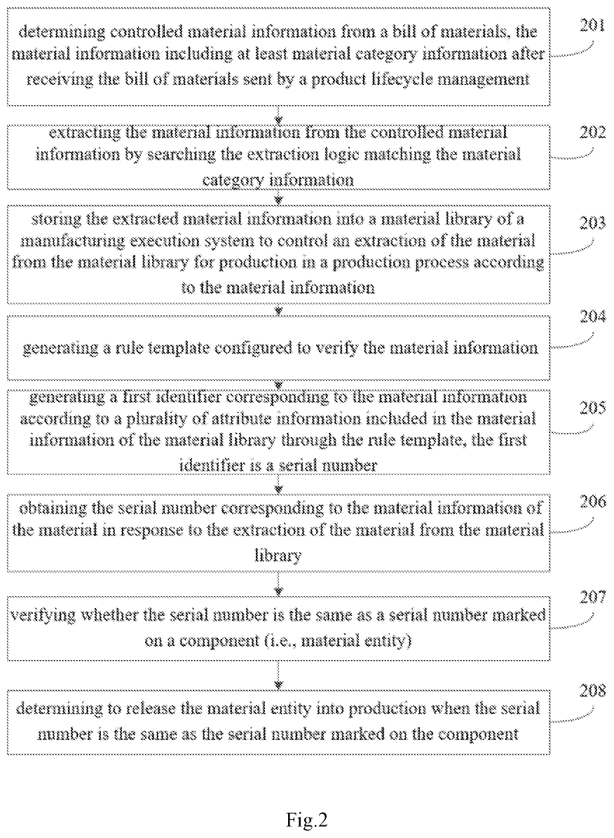

In order to provide a more detailed description of the foregoing embodiment, a method of automatically transmitting the product master data information is further provided in an embodiment of the present disclosure, as shown in FIG. 2, a verification rule is further customized for the key material after putting the product master data information into the MES for maintenance, so that the key material is automatically verified before being released into production to ensure that the key material is not mis-released, wrong-released, or over-released. The following specific steps are provided in the embodiments of this disclosure.

Step 201, determining controlled material information from a bill of materials, the material information including at least material category information after receiving the bill of materials sent by a product lifecycle management.

In the embodiment of the present disclosure, a further detailed description is given below on the determining the controlled material information from the bill of materials.

Firstly, obtaining description information of a material from the bill of materials, and determining the material category information corresponding to the material according to the description information.

In some embodiments, the determining the material category information corresponding to the material according to the description information includes parsing the material category information corresponding to the material from the description information. For example, material category information “POL” may be obtained by parsing description information “POL_10.1WUXGA_F_03_0-TAC_HC_ADS_/” exemplified in Table 1, which is short for polarizer.

Secondly, predetermining a first mapping relationship between the material category information and a control identifier, where the control identifier is configured to indicate that a material marked with the control identifier is within a control range; determining whether there is a control identifier matching the determined material category information according to the first mapping relationship; determining that the material corresponding to the material category information is within the control range when there is the control identifier matching the determined material category information; and searching the bill of materials according to the material category information, and obtaining material information included by the material corresponding to the material category information.

In some embodiments, it is determined whether there is the control identifier matching the parsed material category information by searching a preset mapping relationship (i.e., the first mapping relationship) between the material category information and the control identifier. It is determined that the material corresponding to the material category information is within the control range when there is the control identifier matching the parsed material category information; the material belonging to the material category information is searched in the entire BOM data and then the material information is further obtained.

In the embodiment of the present disclosure, specified material categories may be marked with the control identifier in advance according to a control requirement, that is, the materials belonging to the material categories are controlled. Therefore, after parsing and obtaining the material category information from the description information, it may be determined which material information in the entire BOM data needs to be controlled according to the preset mapping relationship between the material category information and the control identifier.

Step 202, extracting the material information from the controlled material information by searching the extraction logic matching the material category information.

In the embodiment of the present disclosure, before performing the extraction operation, a mapping relationship between a material category, a coding segment, an MES extraction logic and a MES material type needs to be constructed in advance, so that the extraction operation is performed in the given controlled material information through the corresponding extraction logic for different material categories according to the mapping relationship. The constructing the mapping relationship includes the following specific steps.

Firstly, decomposing the material category information into a plurality of material types, and obtaining a correspondence relationship between the material category information and the plurality of material types.

For example, a material category “PCBA” (PCBA is an abbreviation of Printed Circuit Board+Assembly, which means that a PCB empty board goes through a Surface Mount Technology (SMT) loading or goes through an entire process of a Dual Inline Package (DIP) plug-in) is divided into five types, i.e., PCBU1, PCBU2, PCBU3, PCBU4 and PCB according to that for different utilized positions of the materials (i.e., components), such as: for a same category of components, due to different structures, shapes, functions, etc., requirement positions for installation on a circuit board are also different. PCBU1 corresponding to a utilized position of a component is “R_ and R2”; PCBU2 corresponding to a utilized position of a component is “L_ and R1”; PCBU3 corresponding to a utilized position of a component is “L1”; PCBU4 corresponding to a utilized position of a component is “L2”; PCB corresponding to a utilized position of a component is “/_” (i.e., unlimited).

In the above example, “R_” denotes a right side, “R1” and “R2 ” denote first and second positions on the right side, “L_” denotes a left side, and “L1” and “L2” denote first and second positions on the left side , “/_” denotes an unlimited position.

Secondly, allocating different extraction logics to different material types according to that the utilized positions of the components corresponding to different material categories are different, and establishing a second mapping relationship between each of the material types and a corresponding allocated extraction logic.

For example, since PCBU1 corresponding to the utilized position of the component is “R_ and R2”, a corresponding allocated extraction logic is “24th-25th bits in the description: R_ and R2”. It should be noted herein that the extraction logic is essentially to extract the utilized position corresponding to PCBU1. “24th-25th bits in the description” means that characters of 24th-25th bits in the description information is used to denote the utilized position of the component. For example, characters of 24th-25th bits in description information “X-PCBA [symbol] _ HV490QUB-B25_R_/” is “R_”.

Thirdly, predetermining a correspondence relationship between the material category information and a coding segment, where the coding segment is obtained by coding the material category information using a customized coding method.

In the embodiment of the present disclosure, the coding segment is obtained by editing according to an enterprise customized coding method, which is usually also confidential. In order to facilitate a collation of a large amount of data information, the edited coding segments are different for different material category information. In the embodiment of the present disclosure, the extraction logic is to extract a specified code segment for material types included in certain material category information.

Lastly, establishing a third mapping relationship between the material category information, the coding segment, the preset extraction logic and the plurality of material types by storing the correspondence relationship between the material category information and the plurality of material types, the second mapping relationship between the material type and the corresponding preset extraction logic and the correspondence relationship between the material category information and the coding segment into a same data mapping table, such as Table 2.

TABLE 2

| | | | | MES |
|---|---|---|---|---|
| Sequence | Material | coding | | material |
| number | category | segment | MES extraction logic | type |
| 1 | POL | ****** | After a second underscore | POLT |
| | | | in the description: F | |
| | | | After a second underscore | POLB |
| | | | in the description: R | |
| 2 | PCBA | ###### | 24th-25th bits in the | PCBA1 |
| | | | description: R_and R2 | |
| | | | 24th-25th bits in the | PCBA2 |
| | | | description: L_and L1 | |
| | | | 24th-25th bits in the | PCBA3 |
| | | | description: L1 | |
| | | | 24th-25th bits in the | PCBA4 |
| | | | description: L2 | |
| | | | 24th-25th bits in the | PCB |
| | | | description: /_{—} | |
| 3 | BLU | &&&& | Coding segment: 44-800 | BL |
| . . . | . . . | . . . | . . . | . . . |
| . . . | . . . | . . . | . . . | . . . |

It should be noted that “******”, “######” and “&&&&” are enterprise customized coding segments, which may be set by each enterprise according to requirements. Only meaningless characters are used herein. It is known to those of skill in the art that these characters do not limit a character length of the coding segment and do not denote any meaning.

Further, after establishing the third mapping relationship between the material category information, the coding segment, the preset extraction logic and the material type, specific extraction operations may be performed based on the data mapping table, which includes the following specific steps.

Firstly, obtaining description information of a material from the controlled material information, and determining the material category information corresponding to the material according to the description information.

In some embodiments, the determining the material category information corresponding to the material according to the description information includes parsing the material category information corresponding to the material from the description information.

For example, material category information parsed from description information “POL_10.1WUXGA_F_03_0-TAC_HC_ADS_/” exemplified in Table 1 is “POL” (i.e., polarizer). Material category information parsed from description information “X-PCBA_ [symbol] _ HV490QUB-B25_R_/” exemplified in Table 1 is “PCBA”.

Secondly, obtaining the preset extraction logic corresponding to the material category information by searching the data mapping table using the material category information.

In some embodiments, a plurality of preset extraction logics corresponding to the material category information may be obtained by searching the data mapping table using the material category information.

The data mapping table has been constructed in advance, as shown in Table 2, and includes mapping relationships between the material category information, the coding segment, the preset extraction logic and the material type. Then in the embodiment of the present disclosure, after parsing and obtaining the material category information from the description information, such as “PCBA”, a plurality of preset extraction logics corresponding to “PCBA” as follows are obtained by searching the data mapping table: 24th-25th bits in the description: R_ and R2, 24th-25th bits in the description: L_ and L1, 24th-25th bits in the description: L1, 24th-25th bits in the description: L2, and 24th-25th bits in the description: /_.

By analyzing the above extraction logic, there are seven kinds of MES extraction logics actually corresponding to different utilized positions “R”, “R1”, “R2”, “L”, “L1”, “L2” and “/_” of PCBA components respectively, and the seven kinds of MES extraction logics respectively match five types (PCBU1, PCBU2, PCBU3, PCBU4, PCB).

Lastly, determining whether there is an extraction logic matching the description information in the plurality of preset extraction logics; and extracting the material information included by the material corresponding to the description information when there is the extraction logic matching the description information in the plurality of preset extraction logics.

After parsing the material category information included in the description information, the description information and the material category information may be matched with the plurality of corresponding preset extraction logics, that is, determining which extraction logic is used to extract the description information, or none of the plurality of preset extraction logics can extract specified characters in the description information.

For example, for PCBA, after searching and obtaining the plurality of corresponding preset extraction logics according to the data mapping table, 24th-25th bits extracted from the description information “X-PCBA_ [symbol] _HV490QUB-B25_R_/” is “R_”, then the extraction logic matching the description information is “24th-25th bits in the description: R_ and R2”. Thus it is determined that there is an extraction logic in the plurality of preset extraction logics matching the description information, a material corresponding to the description information is within a maintenance range, and material information included in the material needs to be extracted from the controlled material information and put into the MES for maintenance as product master data information.

Further, in the embodiment of the present disclosure, after obtaining the extraction logic matching the description information is “24th-25th bits in the description: R_ and R2”, a material type corresponding to the extraction logic “24th-25th bits in the description: R_ and R2” is “PCBU1” by searching the data mapping table, which is equivalent to that the material type corresponding to the material information is further indirectly determined while extracting the material information including specified description information.

Step 203, storing the extracted material information into a material library of a manufacturing execution system to control an extraction of the material from the material library for production in a production process according to the material information.

For the above steps 201-202, in the process of extracting the product master data information that needs to be maintained extracted from the controlled material information through the MES, and original attribute information of a piece of material information is further indirectly determined based on the original entire BOM, such as the attribute information of “Searching Number”, “Component ID”, “Version” and “Version Description” included in the entire BOM mentioned in step 101, or attribute information of “Product Number”, “Material Group” and “Substitution Group” and etc. is further included. The material category information and the material type included in the extracted material information are also indirectly determined after performing the extraction operation. Therefore, in the embodiment of the present disclosure, when the extracted material information is put into the material library of the MES, a purpose of automatically registering the material is achieved, and the extracted material information stored into the MES includes the above-mentioned attribute information of the original BOM, as well as the material category information and the material type.

In the embodiment of the present disclosure, the extracted material information is used as the product master data information and stored in the material library created in the MES, so as to achieve control and maintenance of the product master data information in the production process.

Step 204, generating a rule template configured to verify the material information.

In the embodiment of the present disclosure, a verification rule is further customized for the key material, so that the key material is automatically verified before being released into production to ensure that the key material is not mis-released, wrong-released, or over-released.

Several rule templates in the following are provided in the embodiments of the present disclosure.

For example: “last four bits of the material number”+“version number”+“*” are used to form the verification rule to obtain the rule template.

For example, for a material type BLU, which is short for “backlight”, 16 “!”+“B”+“last four bits of the material number”+“*” are used to form the verification rule to obtain the rule template. The 16 “!” may also be replaced with reservation information that allows custom filling.

For another example: 4th-8th bits of “Product ID”+“last three bits of the material number”+“version number”+“*” are used to form the verification rule to obtain the rule template.

In the embodiment of the present disclosure, after the verification rule is determined, the rule template configured to verify the material information may be automatically constructed, and the automatically constructed verification rule template is used to facilitate automatic completion of subsequent verification operations for the material information. The manual arbitrary allocation rules in the related art is replaced to greatly facilitate the informatization maintenance of the product master data information, thereby ensuring timeliness and accuracy of the verification. In addition, different verification rule templates may be allocated to materials in different groups in the embodiment of the present disclosure, so that there are various verification foolproof rules.

Step 205, generating a first identifier corresponding to the material information according to a plurality of attribute information included in the material information of the material library through the rule template.

In some embodiments, the first identifier may be a serial number. The rule template is used to integrate the plurality of attribute information included in the material information in the material library to generate a serial number corresponding to the material information.

In the embodiment of the present disclosure, after obtaining the piece of material information, the constructed rule template may be used to automatically integrate the plurality of attribute information (such as product ID, material category, material number, version number, etc.) included in the material information to generate the corresponding serial number according to template requirements.

For example, “last four bits of the material number”+“version number”+“*” are used to form the verification rule to obtain the rule template. For PCBA material information, last four bits of the material number and version number in the material information are obtained from the material library of the MES, and a serial number such as “26210*” is automatically generated.

Step 206, obtaining the first identifier corresponding to the material information of the material in response to the extraction of the material from the material library.

Step 207, verifying whether the first identifier is the same as a first identifier marked on a component (i.e., material entity).

Step 208, determining to release the material entity into production when the first identifier is the same as the first identifier marked on the component.

In the embodiment of the present disclosure, a function of the serial number corresponding to the material information generated through the rule template is given in detail in the above steps 206-208.

The product master data information is maintained by the MES, that is, an entire process of a material being used is tracked and recorded by the MES, for example, which material is about to be released into production, when released into production, it is clearly recorded that the material has been completed being released into production, etc. However, how to verify whether a content recorded by the MES is consistent with an actual release operation in an actual production process, a specific method given in the embodiment of the present disclosure is: in response to extracting the material from the material library to release into production, comparing the serial number corresponding to the material information recorded in the MES is the same as a serial number already marked on a component entity. For example, when the MES records that a material is about to be released into production, a serial number of the material entity is obtained by such as scanning manually a component to be selected using a code scanning gun, when the serial number corresponding to the material information recorded by the MES is the same with the serial number scanned by the code scanning gun, it is determined that the component is selected and released into production, so that a tracking record of the component is also realized by the

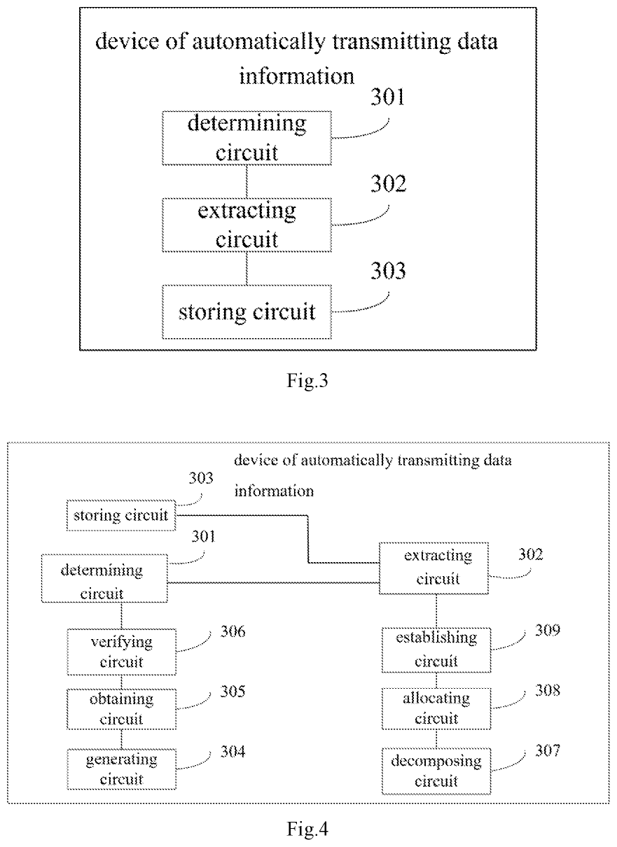

Further, as an implementation of the method shown in FIG. 1 and FIG. 2, a device of automatically transmitting data information is provided in an embodiment of the present disclosure. The device embodiment corresponds to the foregoing method embodiments. For ease of reading, the details in the foregoing method embodiments are not repeated in the device embodiment, but it should be clear that the device in the embodiment may correspondingly implement all the contents in the foregoing method embodiments. The device is used to automatically extract the product master data information that needs to be maintained and to generate verification rules configured to verify the device to be released. As shown in FIG. 3, the device includes a determining circuit 301, an extracting circuit 302 and a storing circuit 303.

The determining circuit 301 is configured to receive a bill of materials, and determine controlled material information from the bill of materials, the material information comprising at least material category information.

The extracting circuit 302 is configured to determine an extraction logic matching the material category information, and extract material information from the controlled material information according to the extraction logic.

The storing circuit 303 is configured to store the material information extracted by the extracting circuit into a material library of a manufacturing execution system to control an extraction of a material from the material library for production in a production process according to the material information.

Further, the determining circuit 301 is further configured to receive the bill of materials sent by a product lifecycle management through an enterprise service bus.

Further, as shown in FIG. 4, the device further includes a generating circuit 304, a obtaining circuit 305 and a verifying circuit 306.

The generating circuit 304 is configured to generate a rule template configured to verify the material information; and generate a first identifier corresponding to the material information according to a plurality of attribute information comprised in the material information of the material library through the rule template.

The obtaining circuit 305 is configured to obtain the first identifier corresponding to the material information of the material in response to the extraction of the material from the material library.

The verifying circuit 306 is configured to verify whether the first identifier is the same as a first identifier marked on a material entity.

The determining circuit 301 is further configured to determine to release the material entity into production when the first identifier is the same as the first identifier marked on the material entity.

Further, as shown in FIG. 4, the determining circuit 301 is further configured to: obtain description information of a material from the bill of materials; determine the material category information corresponding to the material according to the obtained description information; determine that the material corresponding to the material category information is within a control range according to the material category information; and search the bill of materials according to the material category information, and obtain material information comprised by the material corresponding to the material category information.

Further, as shown in FIG. 4, the determining circuit 301 is further configured to: predetermine a first mapping relationship between the material category information and a control identifier, wherein the control identifier is configured to indicate that a material marked with the control identifier is within the control range; determine whether there is a control identifier matching the determined material category information according to the first mapping relationship; and determine that the material corresponding to the material category information is within the control range when there is the control identifier matching the determined material category information.

Further, as shown in FIG. 4, the device further includes a decomposing circuit 307, an allocating circuit 308 and an establishing circuit 309.

The decomposing circuit 307 is configured to decompose the material category information into a plurality of material types, and obtain a correspondence relationship between the material category information and the plurality of material types;

The allocating circuit 308 is configured to allocate preset extraction logics to the plurality of material types.

The establishing circuit 309 is configured to establish a second mapping relationship between each of the plurality of material types and a corresponding preset extraction logic.

Further, as shown in FIG. 4, the establishing circuit 309 is further configured to: predetermine a correspondence relationship between the material category information and a coding segment, wherein the coding segment is obtained by coding the material category information using a customized coding method; and establish a third mapping relationship between the material category information, the coding segment, the preset extraction logic and the plurality of material types by storing the correspondence relationship between the material category information and the plurality of material types, the second mapping relationship and the correspondence relationship between the material category information and the coding segment into a same data mapping table.

Further, as shown in FIG. 4, the determining circuit 301 is further configured to determine the extraction logic matching the material category information according to the material category information and the third mapping relationship.

Further, as shown in FIG. 4, the extracting circuit 302 is further configured to: obtain description information of a material from the controlled material information; determine the material category information corresponding to the material according to the description information; search the data mapping table through the material category information and obtain the preset extraction logic corresponding to the material category information; determine whether there is an extraction logic matching the description information in the preset extraction logic; and extract the material information comprised by the material corresponding to the description information when there is the extraction logic matching the description information in the preset extraction logic.

Further, as shown in FIG. 4, the extracting circuit 302 is further configured to: obtain the extraction logic matching the description information when determining there is the extraction logic matching the description information in the preset extraction logic; search the data mapping table through the extraction logic and obtain a material type corresponding to the extraction logic; determine a matching relationship between the description information and the material type according to the material type corresponding to the extraction logic; and determine the material type to which the material information comprising the description information belongs according to the matching relationship between the description information and the material type.

An electronic device is further provided in the embodiments of the present disclosure, including: a memory, a processor, and a program stored in the memory and executable by the processor, wherein the processor is configured to execute the program to perform the method of automatically transmitting the data information.

A computer-readable storage medium is further provided in the embodiments of the present disclosure, storing a computer program, where the computer program is executed to perform the method of automatically transmitting the data information.

The method and device of automatically transmitting data information are provided in the embodiment of the present disclosure. While the mass production BOM is sent by the PLM to the ERP, the entire BOM data is sent to the Enterprise Service Bus (ESB). The controlled key material information is obtained from the entire BOM data received from the ESB through the MES, and the material information that needs to be maintained, i.e., the product master data information, is further extracted from the controlled key material information. Compared with the related art, the problems of low data input efficiency and insufficient timely and accurate maintenance caused by the manual input of the product master data information are solved. The product master data information that needs to be maintained is automatically extracted through the MES in the embodiment of the present disclosure, that is, the automatic transmission of the product master data information between the PLM and the MES is realized, and inputting information automatically into the MES is completed, thereby improving the efficiency of inputting the product master data information into the MES. The automatic input, rather than the manual input , is used in the present disclosure to avoid finding that the material information to be maintained is not maintained just before releasing, thereby ensuring the efficiency, timeliness and accuracy of the MES maintenance of the product master data information. In addition, the verification rule is further customized for the key material after putting the product master data information into the MES for maintenance, so that the key material is automatically verified before being released into production to ensure that the key material is not mis-released, wrong-released, or over-released.

Those skilled in the art should understand that the embodiments of the present disclosure may be provided as a method, a device, or a computer program product. Therefore, the embodiments of the present disclosure may be a form of a full hardware embodiment, a full software embodiment, or an embodiment combining software and hardware. Moreover, the embodiments of the present disclosure may be a form of a computer program product implemented on one or more computer-usable storage media (including but not limited to disk storage, CD-ROM, optical storage, etc.) containing computer-usable program code.

The embodiments of the present disclosure are described with reference to flowcharts and/or block diagrams of the method, the device (system) and the computer program product in the embodiments of the present disclosure. It should be appreciated that each process in the flowcharts and/or each block in the block diagrams, and a combination of a process in the flowcharts and/or a block in the block diagrams may be implemented by computer program instructions. The computer program instructions may be provided to a processor of a general purpose computer, a special purpose computer, an embedded processor, or other programmable data processing device to produce a machine, such that the instructions executed by the processor of the computer or other programmable data processing device produces a device of realizing functions specified in one or more processes in the flowcharts and/or one or more blocks in the block diagrams.

The computer program instructions may also be stored in a computer-readable memory capable of directing a computer or other programmable data processing device to operate in a particular manner, such that the instructions stored in the computer-readable memory produce a manufacture including an instruction device, the instruction device implements functions specified in one or more processes in the flowcharts and/or one or more blocks in the block diagrams.

The computer program instructions may also be loaded onto the computer or other programmable data processing device, so that a series of operating steps may be performed on the computer or other programmable device to produce computer-implemented processing, and thus the instructions executed by the computer or other programmable device provide steps for implementing the functions specified in one or more processes in the flowcharts and/or one or more blocks in the block diagrams.

In a typical configuration, a computing device includes one or more processors (CPUs), an input/output interface, a network interface, and a memory.

The memory may include a non-persistent memory, a random access memory (RAM), and/or a non-volatile memory in a computer-readable medium, such as a read-only memory (ROM) or a flash random access memory (flash RAM). The memory is an example of the computer-readable medium.

The computer readable medium including a persistent medium and a non-persistent medium, a movable medium and a non-movable medium, may store information through any method or technology. The information may be computer-readable instructions, data structures, modules of programs or other data. Examples of the computer storage medium include, but are not limited to, a Phase-change Random Access Memory (PRAM), a Static Random Access Memory (SRAM), a Dynamic Random Access Memory (DRAM), other types of Random Access Memory (RAM), a Read-Only Memory (ROM), an Electrically Erasable Programmable Read-Only Memory (EEPROM), a flash memory or other memory technologies, a Compact Disc Read-Only Memory (CD-ROM), a Digital Versatile Disc (DVD) or other optical storage, a cassette tape, a tape magnetic disk storage or other magnetic storage device or any other non-transmission medium. The computer storage medium may store information that may be accessed by a computing device. According to a definition in the present disclosure, the computer readable medium does not include a transitory medium, such as a modulated data signal and a carrier.

It should be noted that, a term “include”, “have” or any other variation thereof are intended to encompass non-exclusive inclusion, such that a process, method, product or device including a series of elements includes not only those elements, but also other elements not explicitly listed, or elements inherent to the process, method, product or device. Without more restrictions, an element defined by an expression “including a . . . ” does not exclude the existence of other identical elements in the process, method, product or device including the element.

The aforementioned are merely embodiments of the present disclosure, and are not intended to limit the present disclosure. Those of skill in the art may make various modifications and changes to the present disclosure. Any modifications, replacements or improvements without departing from the spirit and the principle of the present disclosure should be encompassed in the scope of claims of the present disclosure.

What is claimed is:

1. A method of automatically transmitting data information, comprising:
receiving a bill of materials;
determining controlled material information from the bill of materials, the material information comprising at least material category information;
determining an extraction logic matching the material category information;
extracting material information from the controlled material information according to the extraction logic; and
storing the extracted material information into a material library of a manufacturing execution system to control an extraction of a material from the material library for production in a production process according to the material information.

2. The method according to claim 1, wherein the receiving the bill of materials comprises:
receiving the bill of materials sent by a product lifecycle management through an enterprise service bus.

3. The method according to claim 2, further comprising:
generating a rule template configured to verify the material information;
generating a first identifier corresponding to the material information according to a plurality of attribute information comprised in the material information of the material library through the rule template;
obtaining the first identifier corresponding to the material information of the material in response to the extraction of the material from the material library;
verifying whether the first identifier is the same as a first identifier marked on a material entity; and
determining to release the material entity into production in the case that the first identifier is the same as the first identifier marked on the material entity.

4. The method according to claim 1, wherein the determining the controlled material information from the bill of materials comprises:
obtaining description information of a material from the bill of materials;
determining the material category information corresponding to the material according to the description information;
determining that the material corresponding to the material category information is within a control range according to the material category information; and
searching the bill of materials according to the material category information, and obtaining material information comprised by the material corresponding to the material category information.

5. The method according to claim 4, wherein the determining that the material corresponding to the material category information is within the control range according to the material category information comprises:
predetermining a first mapping relationship between the material category information and a control identifier, wherein the control identifier is configured to indicate that a material marked with the control identifier is within the control range;
determining whether there is a control identifier matching the determined material category information according to the first mapping relationship; and
determining that the material corresponding to the material category information is within the control range in the case that there is the control identifier matching the determined material category information.

6. The method according to claim 1, wherein prior to the determining the extraction logic matching the material category information, the method further comprises:
decomposing the material category information into a plurality of material types, and obtaining a correspondence relationship between the material category information and the plurality of material types;
allocating preset extraction logics to the plurality of material types; and
establishing a second mapping relationship between each of the plurality of material types and a corresponding preset extraction logic.

7. The method according to claim 6, further comprising:
predetermining a correspondence relationship between the material category information and a coding segment, wherein the coding segment is obtained by coding the material category information using a customized coding method; and
establishing a third mapping relationship between the material category information, the coding segment, the preset extraction logic and the plurality of material types by storing the correspondence relationship between the material category information and the plurality of material types, the second mapping relationship and the correspondence relationship between the material category information and the coding segment into a same data mapping table.

8. The method according to claim 7, wherein the determining the extraction logic matching the material category information comprises:
determining the extraction logic matching the material category information according to the material category information and the third mapping relationship.

9. The method according to claim 8, wherein the extracting the material information from the controlled material information according to the extraction logic comprises:
obtaining description information of a material from the controlled material information;
determining the material category information corresponding to the material according to the description information;
searching the data mapping table through the material category information, and obtaining the preset extraction logic corresponding to the material category information;
determining whether there is an extraction logic matching the description information in the preset extraction logic; and
extracting the material information comprised by the material corresponding to the description information in the case that there is the extraction logic matching the description information in the preset extraction logic.

10. The method according to claim 9, further comprising:
obtaining the extraction logic matching the description information in the case that there is the extraction logic matching the description information in the preset extraction logic;
searching the data mapping table through the extraction logic, and obtaining a material type corresponding to the extraction logic;
determining a matching relationship between the description information and the material type according to the material type corresponding to the extraction logic; and
determining the material type to which the material information comprising the description information belongs according to the matching relationship between the description information and the material type.

11. A device of automatically transmitting data information, comprising:
a determining circuit, configured to receive a bill of materials and determine controlled material information from the bill of materials, the material information comprising at least material category information;
an extracting circuit, configured to determine an extraction logic matching the material category information and extract material information from the controlled material information according to the extraction logic; and
a storing circuit, configured to store the material information extracted by the extracting circuit into a material library of a manufacturing execution system to control an extraction of a material from the material library for production in a production process according to the material information.

12. The device according to claim 11, further comprising:
a generating circuit, configured to generate a rule template configured to verify the material information and generate a first identifier corresponding to the material information according to a plurality of attribute information comprised in the material information of the material library through the rule template;
a obtaining circuit, configured to obtain the first identifier corresponding to the material information of the material in response to the extraction of the material from the material library; and
a verifying circuit, configured to verify whether the first identifier is the same as a first identifier marked on a material entity;
wherein the determining circuit is further configured to determine to release the material entity into production in the case that the first identifier is the same as the first identifier marked on the material entity.

13. The device according to claim 11, wherein the determining circuit is further configured to:
obtain description information of a material from the bill of materials;
determine the material category information corresponding to the material according to the obtained description information;
determine that the material corresponding to the material category information is within a control range according to the material category information; and
search the bill of materials according to the material category information, and obtain material information comprised by the material corresponding to the material category information.

14. The device according to claim 13, wherein the determining circuit is further configured to:
predetermine a first mapping relationship between the material category information and a control identifier, wherein the control identifier is configured to indicate that a material marked with the control identifier is within the control range;
determine whether there is a control identifier matching the determined material category information according to the first mapping relationship; and
determine that the material corresponding to the material category information is within the control range in the case that there is the control identifier matching the determined material category information.

15. The device according to claim 11, further comprising:
a decomposing circuit, configured to decompose the material category information into a plurality of material types and obtain a correspondence relationship between the material category information and the plurality of material types;
an allocating circuit, configured to allocate preset extraction logics to the plurality of material types; and
an establishing circuit, configured to establish a second mapping relationship between each of the plurality of material types and a corresponding preset extraction logic.

16. The device according to claim 15, wherein the establishing circuit is further configured to:
predetermine a correspondence relationship between the material category information and a coding segment, wherein the coding segment is obtained by coding the material category information using a customized coding method; and establish a third mapping relationship between the material category information, the coding segment, the preset extraction logic and the plurality of material types by storing the correspondence relationship between the material category information and the plurality of material types, the second mapping relationship and the correspondence relationship between the material category information and the coding segment into a same data mapping table;
the determining circuit is further configured to determine the extraction logic matching the material category information according to the material category information and the third mapping relationship.

17. The device according to claim 16, wherein the extracting circuit is further configured to:
obtain description information of a material from the controlled material information;
determine the material category information corresponding to the material according to the description information;
search the data mapping table through the material category information and obtain the preset extraction logic corresponding to the material category information;
determine whether there is an extraction logic matching the description information in the preset extraction logic; and
extract the material information comprised by the material corresponding to the description information in the case that there is the extraction logic matching the description information in the preset extraction logic.

18. The device according to claim 17, wherein the extracting circuit is further configured to:
obtain the extraction logic matching the description information in the case that there is the extraction logic matching the description information in the preset extraction logic;
search the data mapping table through the extraction logic and obtain a material type corresponding to the extraction logic;
determine a matching relationship between the description information and the material type according to the material type corresponding to the extraction logic; and
determine the material type to which the material information comprising the description information belongs according to the matching relationship between the description information and the material type.

19. An electronic device, comprising: a memory, a processor and a program stored in the memory and executable by the processor, wherein the processor is configured to execute the program to perform the method of automatically transmitting data information according to claim 1.

20. A computer-readable storage medium storing a computer program, wherein the computer program is executed to perform the method of automatically transmitting data information according to claim 1.
